(19) United States
(12) Patent Application Publication
(10) Pub. No.: US 2026/0276434 A1
(43) Pub. Date: Sep. 17, 2026

(54) METHOD TO ESTIMATE VEHICLE MASS

(71) Applicants: FCA US LLC, Auburn Hills, MI (US); Stellantis Auto SAS, Poissy (FR)

(72) Inventor: Lubna S Khasawneh, Auburn Hills, MI (US)

(21) Appl. No.: 19/079,785

(22) Filed: Mar. 14, 2025

(51) Int. Cl. G01G 19/08; G07C 5/02

(52) U.S. Cl. CPC G01G 19/086; G07C 5/02

(57) ABSTRACT

A method for estimating vehicle mass includes obtaining or determining a longitudinal acceleration of the vehicle, determining a total force as a function of a wheel force, an aerodynamic force determined as a function of a surface area of part of the vehicle, a rolling resistance force, and a force of gravity; providing a regression formula including the total force and longitudinal acceleration and using a Kalman filter to solve the regression formula and determine an estimated vehicle mass. The estimated vehicle mass can be used in various vehicle control systems to improve vehicle control dynamics.

### FIELD

The present disclosure relates to methods for estimating vehicle mass.

### BACKGROUND

The mass of a vehicle changes over time due to changes in, for example, amount of fuel level in a fuel tank, number of occupants in the vehicle, cargo in or on the vehicle and whether the vehicle is towing a trailer. The vehicle mass is an important input into various vehicle control systems including vehicle safety systems, braking systems, acceleration control and the like. Using a constant value for vehicle mass does not take into account the changes in vehicle mass that occur in use of the vehicle and can lead to compromises in vehicle dynamics and control.

### SUMMARY

In at least some implementations, a method for estimating vehicle mass includes obtaining or determining a longitudinal acceleration of the vehicle, determining a total force as a function of a wheel force, an aerodynamic force determined as a function of a surface area of part of the vehicle, a rolling resistance force, and a force of gravity; providing a regression formula including the total force and longitudinal acceleration and using a Kalman filter to solve the regression formula and determine an estimated vehicle mass. The estimated vehicle mass can be used in various vehicle control systems to improve vehicle control dynamics.

In at least some implementations, the wheel force is determined as a function of a wheel size and a torque acting on the wheel. In at least some implementations, the aerodynamic force is determined as a function of air density, a drag coefficient and the vehicle speed. In at least some implementations, the rolling resistance is determined as a function of a rolling resistance coefficient and gravitational acceleration.

In at least some implementations, the gravitational force is determined as a function of a road slope along which the vehicle is traveling. In at least some implementations, the road slope is determined as a function of data from a vehicle inertial measurement unit.

In at least some implementations, the Kalman filter includes a prediction of a vehicle mass and prediction of an error variance which is determined as a function of a process variance which is a tunable design parameter. In at least some implementations, the Kalman filter includes determining a Kalman gain and a residual variance, where the residual variance is determined as a function of a measurement variance which is a tunable design parameter. In at least some implementations, the Kalman filter includes updating the error variance and updating the predicted vehicle mass which is the estimated vehicle mass. In at least some implementations, the estimated vehicle mass is provided to a vehicle control system and the method is then repeated to determine a new estimated vehicle mass.

In at least some implementations, a method for estimating vehicle mass includes use of a Kalman filter and a regression formula. The method includes setting an initial vehicle mass estimate \hat{x}(0)=\hat{m}(0) and setting an initial error variance p(0), and predicting a next vehicle mass as \hat{x}(k)=a\hat{x}(k−1), where the scalar a is equal to 1, and predicting a next error variance as (k)=a²p(k−1)+q, where q is a process variance variable which is a tunable design parameter. A longitudinal acceleration aₓ(k) of the vehicle is obtained or determined, as is a road slope angle f(k). Next, the formula c=aₓ(k)+fg+gsin(θ(k) is determined, where f is the rolling resistance of the vehicle and g is the gravitational acceleration, and a residual variance is determined as s=c²p(k−1)+r; where r is a measurement variance variable that is a tunable design parameter. The Kalman filter gain is computed as

$$k = \frac{{c}^{2} p ( k - 1 )}{s} ,$$

and a wheel force as

$$( {F}_{x} = \frac{{τ}_{w}}{{R}_{W}} )$$

and an aerodynamic force

$$( {F}_{a} = \frac{1}{2} ρ {C}_{d} {{A}_{f} ( v )}^{2} )$$

are determined, where ρ is an air density, C_{d} is a aerodynamic drag coefficient, A_{f} is a frontal area of the vehicle, and v is the vehicle speed. A difference between the wheel force and the aerodynamic force is determined as y, and a measurement residual error is determined as ∈=y−cx(k−1). Next, the error variance and the vehicle mass are updated, wherein the updated vehicle mass is the estimated vehicle mass.

In at least some implementations, the aerodynamic force is determined also as a function of a wind speed of a wind in which the vehicle is traveling.

In at least some implementations, the Kalman filter is used in a regression formula as

$$\hat{x} ( k ) = \hat{x} ( k - 1 ) + k [ y - c \hat{x} ( k - 1 ) ] = \hat{x} ( k - 1 ) + k [ \underbrace{[ {F}_{x} ( k ) - {F}_{a} ( k ) ]}_{y} - \underbrace{[ {a}_{x} ( k ) + f g + g sin ( θ ( k ) ]}_{c} \hat{x} ( k - 1 ) ] ;$$

where \hat{x}(k)=\hat{m}(k) denotes an optimal estimate of x(k)=m(k), and k is an optimal Kalman gain.

In at least some implementations, the initial value of the error variance p(0) is 1.

In at least some implementations, the initial estimate of the vehicle mass is a predetermined nominal vehicle mass.

In at least some implementations, the predetermined nominal vehicle mass is provided by the vehicle manufacturer.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 illustrates a vehicle with various components and systems diagrammatically shown;

FIG. 2 is a diagrammatic view of a control system of the vehicle;

FIG. 3 is a schematic view of an algorithm for determining error in a measured longitudinal acceleration; and

FIG. 4 is a flowchart of a method for determining error in a measured acceleration.

### DETAILED DESCRIPTION

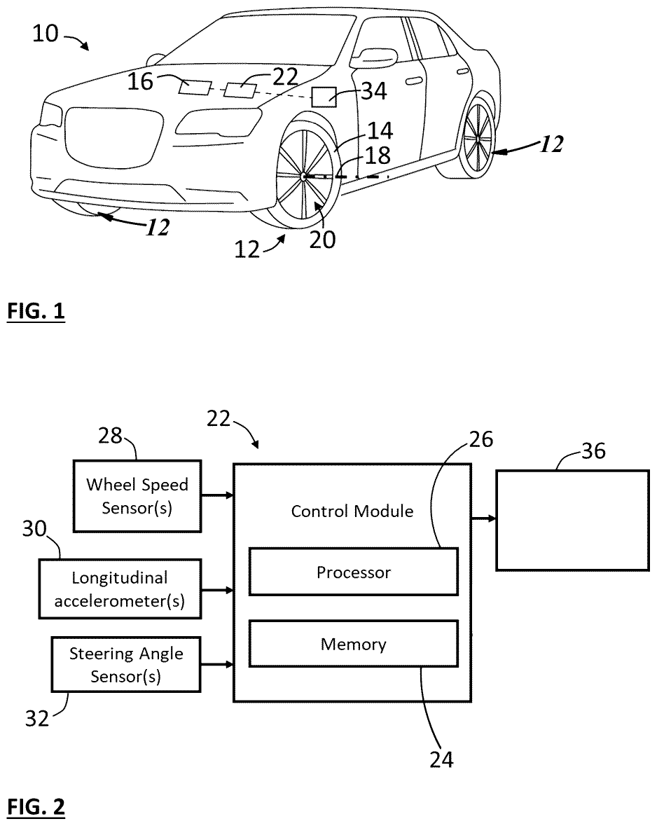

Referring in more detail to the drawings, FIG. 1 illustrates a vehicle 10 that includes multiple wheels 12 with tires 14, and a powertrain system 16 that may include one or both of an electric motor and a combustion engine, and may also include a transmission, via which torque is provided to the wheels 12 to rotate the wheels about axes of rotation 18 and propel the vehicle. The vehicle 10 may also include one or more brakes or brake assemblies 20 to decelerate the vehicle 10 and hold the vehicle stopped. Vehicle speed and acceleration may be determined by one or more wheel speed sensors 28 (FIG. 2) and one or more accelerometers 30. Additionally, steering angle may be determined by one or more steering angle sensors 32. These sensors, among other things, may be communicatively coupled with a controller 22 or control system (e.g., an engine control module). The controller 22 and sensors 28, 30, 32 may be used in control of one or move vehicle functions or systems, like autonomous or partially autonomous vehicle operation, anti-lock brake control, vehicle stability control, traction control, and the like. The controller 22 may include a memory 24 for storing data from the one or more sensors, and instructions or programs, and a processor 26 for processing the data and executing the instructions or programs stored in the memory.

In order to perform the functions and desired processing set forth herein, as well as the computations therefore, the controller 22 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 22 may include input signal processing and filtering to enable accurate sampling and conversion or acquisitions of such signals from communications interfaces and sensors. As used herein the terms controller 22 may refer to one or more processing circuits 26 such as an application specific integrated circuit (ASIC), an electronic circuit, a processor (shared, dedicated, or group) and memory 24 that executes one or more software or firmware programs, a combinational logic circuit, and/or other suitable components that provide the described functionality.

The term “memory” 24 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory 24 can store an operating system and/or instructions/programs executable by a processor or controller or the like to enable control or allocate resources of a computing device.

As shown in FIG. 2, to permit measurement of the rotational speed of the wheels 12, the wheel speed sensor 28 may be associated with one of the wheels 12 to provide an output to the controller 22 that is indicative of the rotation of the wheel. By way of a non-limiting example, the wheel speed sensor 28 may be a hall effect sensor with a magnet being rotated with the wheel or spindle and with a sensing element used to detect the magnet as it rotates by the sensing element. Of course, other types of rotational speed sensors may be used.

Additionally, acceleration may be measured using one or more accelerometers 30 which measures gravitational forces (i.e., g-forces) in a longitudinal (e.g. forward-rearward) direction, a lateral (e.g. cross-car) direction, and vertical (e.g. up/down) direction, as well as rotations about longitudinal, lateral and vertical axes. In at least one embodiment, the one or more accelerometers are defined by an Inertial Measurement Unit (IMU) that is a multi-axis accelerometer which provides simultaneous measurement of acceleration in three perpendicular axes and rotational velocities about the axes, for example.

To measure the position of wheels, the steering angle sensor 32 may be associated with one or more of the wheels 12 or with a steering shaft 34 of the vehicle 10. In at least one embodiment, the steering angle sensor may be a giant magnetoresistance (GMR) device, by way of one non-limiting example, that provides an absolute steering angle value over the complete steering angle range. Other types of sensors may be used, for example but not limited to, tunnel magnetoresistance (TMR) sensors and anisotropic magnetoresistance (AMR) sensors. The steering angle sensor 32 may provide an output that permits steering angle and/or steering angle velocity or rate of change of steering angle to be determined at the controller 22.

One or more systems (shown by 36 in FIG. 2) of vehicle 10 may need the vehicle mass as an input, such as lateral control, longitudinal control, suspension control, and many vehicle state observers, such as lateral velocity and side slip angle. Those algorithms are usually calibrated based on a constant value of the vehicle mass, which is usually provided by the manufacturer and may be the weight of the empty vehicle in a laboratory or manufacturing facility, or some assumed average weight in use. But in reality, vehicle mass is not constant and changes depending on the number of passengers, the fullness of the gas tank, cargo loading and unloading, and the like. Further, if the vehicle is towing a trailer, its mass will significantly change. Thus, the vehicle mass changes, but the vehicle functions and systems are still using the constant value for mass, which is the wrong value in at least some conditions. Also, when the vehicle mass changes from the constant value that was provided, the performance of the vehicle systems will deteriorate because they were calibrated based on the initial constant value.

In at least some implementations, a method/algorithm determines or estimates the vehicle mass, and in at least some implementations, uses a Kalman filter. Kalman filtering (sometimes also known as linear quadratic estimation) is an algorithm that uses a series of measurements observed over time, including statistical noise and other inaccuracies, to produce estimates of unknown variables, rather than estimating based on a single measurement. The Kalman filter can estimate a joint probability distribution over the variables for each time-step, and may be constructed as a mean squared error minimizer.

In general, the Kalman filter works via a two-phase process: a prediction phase and an update phase. In the prediction phase, the Kalman filter produces estimates of the current state variables, including their uncertainties. Once the outcome of the next measurement (necessarily including some error, including noise, bias and sensor offset(s)) is observed, these estimates are updated using a weighted average, with more weight given to estimates with greater certainty. The algorithm is recursive. It can operate in real time, using only the present input measurements and the state calculated previously and its uncertainty matrix; no additional past information is required.

The governing equation of vehicle longitudinal dynamics can be approached according to Newton second law of motion, which is given by: ma=F_{Total}, where, F_{Total}=Fₓ−Fₐ−F_{R}−F_{g}. Here, Fₓ is the force acting on the vehicle tires generated via road-tire interaction, which depends on the torque Tw acting on the wheels and the wheel radius R_{W} as follows:

$${F}_{x} = \frac{{τ}_{w}}{{R}_{W}} .$$

The torque τ_{w} might be obtained directly from another vehicle system or sensor, e.g. available via a CAN bus of the vehicle. If the torque τ_{w} is not available, it can be computed from engine torque and brake torque.

Next, Fₐ is the aerodynamic force given by:

$${F}_{a} = \frac{1}{2} ρ {C}_{d} {{A}_{f} ( v + {v}_{w} )}^{2} ;$$

where ρ is the air density, C_{d} is the aerodynamic drag coefficient, A_{f} is the frontal area of the vehicle, v is the vehicle speed, v_{w} is the wind speed (which can be ignored if not available). F_{R} is the rolling resistance force given by: F_{R}=fmg; where, f is the rolling resistance coefficient which is a constant and may be predetermined or otherwise provided, and g is the gravitational acceleration. F_{g} is the gravitational force given by: F_{g}=mgsin(θ); where θ is the road slope angle, which may be provided by a sensor, location data (e.g. road map data), or estimated from an external algorithm, and F_{g} is the force of gravity.

In view of the above, the equation can be written as: ma=Fₓ−Fₐ−fmg−mgsin(θ). Collecting the terms that contain the unknown term (i.e. the mass) the regression problem yields: Fₓ−Fₐ=maₓ+fmg+mgsin(θ), which can be written in the regression form to separate the known quantities from the unknown as follows: Fₓ−Fₐ=[aₓ+fg+gsin(θ)] m.

Now, we can formulate a Kalman filter to solve the above regression problem: x(k)=x(k−1)+w(k); where x(k) is the estimated parameter m(k), and Fₓ(k)−Fₐ(k)=[aₓ(k)+fg+gsin(θ(k)] m(k)+n(k); where n(k) is the measurement noise. Based on the above system and measurement models, the Kalman filter regression problem takes the form below:

$$\hat{x} ( k ) = \hat{x} ( k - 1 ) + k [ y - c \hat{x} ( k - 1 ) ] = \hat{x} ( k - 1 ) + k [ \underbrace{[ {F}_{x} ( k ) - {F}_{a} ( k ) ]}_{y} - \underbrace{[ {a}_{x} ( k ) + f g + g sin ( θ ( k ) ]}_{c} \hat{x} ( k - 1 ) ] ;$$

where \hat{x}(k)=\hat{m}(k) denotes the optimal estimate of x(k)=m(k), and k is the optimal Kalman gain.

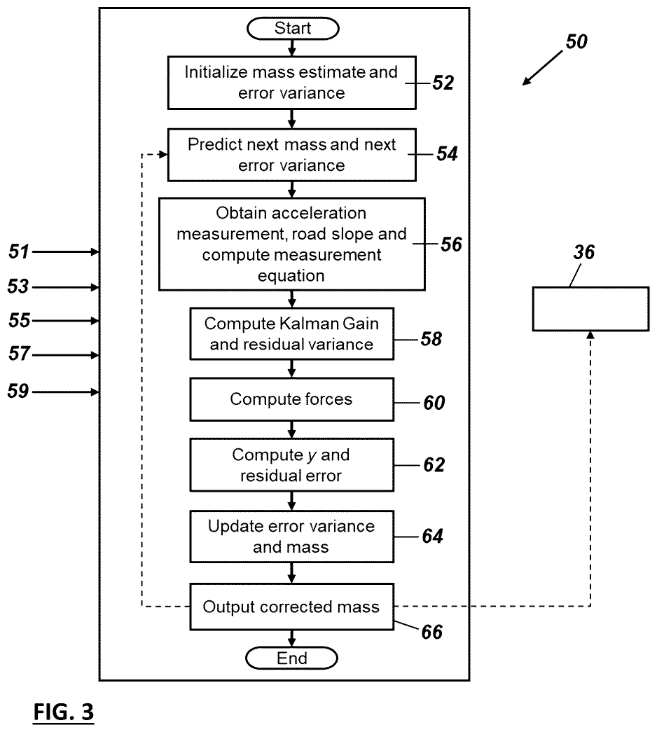

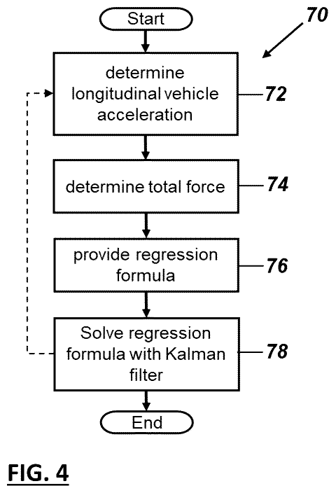

In at least some implementations, a method/algorithm 50 for determining vehicle mass with a Kalman filter is set forth below, and is generally shown in FIGS. 3 and 4. In step 52, the mass estimate is initialized \hat{x}(0)=\hat{m}(0) as is the error variance p(0). In at least some implementations, the error variance is a scalar because it is a first order Kalman filter. The initial value of the mass can be set to the initially known constant value of the mass that resulted from weighing the empty vehicle in the vehicle dynamics laboratory, or from another set value, as desired. The initial value of the error variance can be set to 1.

In step 54, the next state and error variance are predicted: \hat{x}(k)=a\hat{x}(k−1), where the scalar a is the characteristic parameter of the system, which, in at least some implementations, is set to 1. The next error variance is shown as: p(k)=a²p(k−1)+q, where q is the process variance, which is a tunable design parameter, and which is a scalar in this implementation which is a first order Kalman filter. The value of q may be tuned on a trial-and-error basis, and can be set to a relatively large value if the estimated state or parameter is fast changing, and to a small value if it is slowly changing as is the case with vehicle mass.

In step 56, the longitudinal acceleration measurement aₓ(k) and the road slope angle θ(k) are obtained (e.g. from a sensor as input 51 or as computed from another algorithm as input 53). Then, the measurement equation is computed: c=aₓ(k)+fg+gsin(θ(k); where, the rolling resistance f and the gravitational acceleration g are known constants.

In step 58, the residual variance s and Kalman gain k are computed: s=c²p(k−1)+r; and

$$k = \frac{{c}^{2} p ( k - 1 )}{s} ;$$

where r is a tunable design parameter that represents the measurement variance, which is a scalar in this implementation of the algorithm, and which may also be tuned based on trial and error. This design parameter can be set to a large value if the measurement used in the algorithm is very noisy, and should be decreased as the noise in the measurement decreases.

In step 60, the wheel force Fₓ and aerodynamic force Fₐ are computed:

$${F}_{x} = \frac{{τ}_{w}}{{R}_{W}} ; and {F}_{a} = \frac{1}{2} ρ {C}_{d} {{A}_{f} ( v + {v}_{w} )}^{2} ,$$

using wheel torque input 55, vehicle speed input 57, and input 59 which is shown to include known variables and constants, like wheel size (e.g. radius). In step 62, variable y, which in this example is the wheel force minus the aerodynamic force, and the measurement residual error e are computed as: y=Fₓ−Fₐ; and ∈=y−c\hat{x}(k−1). In general, in a regression problem setup, y includes known variables or measurements that do not contain the variable being estimated, and the predicted output Cx includes the equations that contain the estimated variable, and the error is the difference between them. In step 64, the error variance p(k) and the mass estimate \hat{x}(k)=\hat{m}(k) are updated as: p(k)=(1−kc)p(k−1); and \hat{x}(k)=\hat{x}(k−1)+k∈, and this mass estimate may then be outputted in step 66 and used in various vehicle control systems 36 and functions to improve the accuracy of these systems and functions compared to when a set, unchanging mass value is used.

FIG. 4 illustrates a flowchart for a method 70 of determining vehicle mass. In step 72, a longitudinal acceleration of the vehicle is obtained from a vehicle sensor (e.g. the IMU) or determined by an algorithm based on sensor data. In step 74, a total force is determined as a function of a wheel force, an aerodynamic force determined as a function of a surface area of part of the vehicle, a rolling resistance force, and a force of gravity. The rolling resistance may be a known or predetermined and provided constant, and the force of gravity is known.

In step 76, a regression formula is provided that includes the total force and longitudinal acceleration. And in step 78, a Kalman filter is used to solve the regression formula and determine an estimated vehicle mass. Here, the estimated vehicle mass can be used as an updated estimated vehicle mass for a subsequent iteration of the method done to provide a new estimated vehicle mass (as shown generally by the dashed line in FIG. 4). In that regard, and in at least some implementations, the Kalman filter includes a prediction of a vehicle mass and prediction of an error variance which is determined as a function of a process variance which is a tunable design parameter. Further, the Kalman filter may include determining a Kalman gain and a residual variance, where the residual variance is determined as a function of a measurement variance and which also is a tunable design parameter.

The mass of a vehicle can change significantly over time. For example, more or fewer passengers may be in the vehicle, more or less fuel and cargo, and the vehicle may pull a trailer some of the time. All of these things can occur together or individually. Further, the mass of the vehicle may change in use, for example, as fuel is consumed. While mass may be considered to be a slowly varying parameter within a single use, the mass may continually change, and the algorithms and methods taught herein enable updating and improvements to the mass determination of the vehicle.

Some prior vehicle control systems attempted to determine vehicle mass with a method using recursive squares. These methods have limitations because they require persistent excitation, that is, fast changing signals with different magnitudes, like vehicle speed changes and longitudinal accelerations that change fast. If speed and acceleration are constant, or close to constant, the recursive squares methods do not provide accurate results.

What is claimed is:

1. A method for estimating vehicle mass, comprising:
obtaining or determining a longitudinal acceleration of the vehicle;
determining a total force as a function of a wheel force, an aerodynamic force determined as a function of a surface area of part of the vehicle, a rolling resistance force, and a force of gravity;
provide a regression formula including the total force and longitudinal acceleration; and
using a Kalman filter to solve the regression formula and determine an estimated vehicle mass.

2. The method of claim 1 wherein the wheel force is determined as a function of a wheel size and a torque acting on the wheel.

3. The method of claim 1 wherein the aerodynamic force is determined as a function of air density, a drag coefficient and the vehicle speed.

4. The method of claim 1 wherein the rolling resistance is determined as a function of a rolling resistance coefficient and gravitational acceleration.

5. The method of claim 1 wherein the gravitational force is determined as a function of a road slope along which the vehicle is traveling.

6. The method of claim 5 wherein the road slope is determined as a function of data from a vehicle inertial measurement unit.

7. The method of claim 1 wherein the Kalman filter includes predicting a vehicle mass and predicting an error variance which is determined as a function of a process variance which is a tunable design parameter.

8. The method of claim 7 wherein the Kalman filter includes determining a Kalman gain and a residual variance, where the residual variance is determined as a function of a measurement variance which is a tunable design parameter.

9. The method of claim 7 wherein the Kalman filter includes updating the error variance and updating the predicted vehicle mass which is the estimated vehicle mass.

10. The method of claim 9 wherein the estimated vehicle mass is provided to a vehicle control system and the method is then repeated to determine a new estimated vehicle mass.

11. A method for estimating vehicle mass, comprising:
setting an initial vehicle mass estimate \hat{x}(0)=\hat{m}(0) and setting an initial error variance p(0);
predicting a next vehicle mass as \hat{x}(k)=a\hat{x}(k−1), where the scalar a is equal to 1, and predicting a next error variance as (k)=a²p(k−1)+q, where q is a process variance variable which is a tunable design parameter;
obtaining or determining a longitudinal acceleration aₓ(k) of the vehicle;
obtaining or determining a road slope angle θ(k);
determining c=aₓ(k)+fg+gsin(θ(k), where f is the rolling resistance of the vehicle and g is the gravitational acceleration;
determining a residual variance as s=c²p(k−1)+r; where r is a measurement variance variable that is a tunable design parameter;
determining a Kalman filter gain as
$$k = \frac{{c}^{2} p ( k - 1 )}{s} ;$$
determining a wheel force as
$${F}_{x} = \frac{{τ}_{w}}{{R}_{W}} ;$$
determining an aerodynamic force as
$${F}_{a} = \frac{1}{2} ρ {C}_{d} {{A}_{f} ( v )}^{2} ,$$
where ρ is an air density, C_{d} is a aerodynamic drag coefficient, A_{f} is a frontal area of the vehicle, and v is the vehicle speed;
determining a difference between the wheel force and the aerodynamic force as γ;
determining a measurement residual error as ∈=y−c\hat{x}(k−1); and
updating the error variance and the vehicle mass, wherein the updated vehicle mass is the estimated vehicle mass.

12. The method of claim 11 wherein the aerodynamic force is determined also as a function of a wind speed of a wind in which the vehicle is traveling.

13. The method of claim 11 wherein the road slope is determined as a function of data from a vehicle inertial measurement unit.

14. The method of claim 11 wherein the estimated vehicle mass is provided to a vehicle control system and the method is then repeated to determine a new estimated vehicle mass.

15. The method of claim 11 wherein the Kalman filter is used in a regression formula as
$$\hat{x} ( k ) = \hat{x} ( k - 1 ) + k [ y - c \hat{x} ( k - 1 ) ] = \hat{x} ( k - 1 ) + k [ \underbrace{[ {F}_{x} ( k ) - {F}_{a} ( k ) ]}_{y} - \underbrace{[ {a}_{x} ( k ) + f g + g sin ( θ ( k ) ]}_{c} \hat{x} ( k - 1 ) ] ;$$
where \hat{x}(k)=\hat{m}(k) denotes an optimal estimate of x(k)=m(k), and k is an optimal Kalman gain.

16. The method of claim 11 wherein the initial value of the error variance p(0) is 1.

17. The method of claim 11 wherein the initial estimate of the vehicle mass is a predetermined nominal vehicle mass.

18. The method of claim 17 wherein the predetermined nominal vehicle mass is provided by the vehicle manufacturer.
